(19) United States
(12) Patent Application Publication
(10) Pub. No.: US 2014/0332315 A1
(43) Pub. Date: Nov. 13, 2014

(54) Hunting Stand Support System and Apparatus

(71) Applicant: Roy L. Moore, Adairsville, GA (US)

(72) Inventor: Roy L. Moore, Adairsville, GA (US)

(21) Appl. No.: 13/890,420

(22) Filed: May 9, 2013

(51) Int. Cl. A01M 31/02

(52) U.S. Cl. CPC A01M 31/02
USPC 182/129; 248/201

(57) ABSTRACT

Example embodiments of the hunting stand system and apparatus disclosed herein solve this problem by providing support for a hunting weapon or other object. In an example embodiment, a single support device or apparatus can be used to attach to each of the three common widths. An example hunting stand support system and apparatus comprises a first bracket, a second bracket, a support device, and a fastener. In an example embodiment, the first bracket comprises a first notch and a second notch with the second notch configured to be wider than the first notch. The first notch is configured to fit a first rail size, the second notch is configured to fit a second rail size and the distance between the fastener is configured to fit a third rail size.

### TECHNICAL FIELD

The present disclosure is generally related to outdoor activities and, more particularly, is related to support systems associated with a hunting stand.

### BACKGROUND

Tree stands or deer stands are open or enclosed platforms used by hunters. In some cases, platforms are secured to trees in order to elevate the hunter and give him a better vantage point. A tripod stand is a similar device, but because it is freestanding rather than attached to a tree, it is not technically a tree stand. Hunters use many different types of tree stands.

Climbing stands may be made up of two parts: a bottom part and a top part. The bottom part is the standing platform and the top is the seat. A back for the seat is optional. A strap may connect the two parts, so if the bottom falls while in the tree or climbing, the platform doesn't fall all the way to the ground stranding the hunter.

Climbing tree stands use different methods to connect to the tree. A tree wrap section may be constructed from a thick cable or boomerang shaped piece of metal. The tree wrap section may be fastened to the stand with a bolt or pin for easy adjustment for different tree sizes.

Before climbing the tree both parts may be adjusted so they are level for the hunter to stand and sit on. To climb the tree the back of each part is angled to the tree one at a time and pulled up. Then the part that the hunter is moving is set back level and the next part is moved up. This is done until the hunter is at the desired height. For safety some hunters strap the tree stand to the tree. To descend, the hunter performs the same routine in reverse.

Ladder stands may include a stand with a seat and platform along with a ladder to climb up into the stand. A ladder stand includes a seat and platform that connect to the tree with the ladder coming off the front of the platform to give the hunter access to the stand. Ladder stands are generally stationary because of the size and lack of ability to move through the woods quietly. Stability is good because of the connection to the tree and support from the ground. Hunters can use one and two person ladder stands.

Hanging stands can resemble ladder stands without the ladder, and the hanging stand may also be stationary. Hanging stands connect to the tree with chains or cables at the desired height. To get up to a hanging stand hunters use ladders or sections of ladders secured to the tree (called “climbing sticks”), or they may use screw-in steps that screw in to the tree and allow the hunter to climb up to the stand.

Tree stands can give the hunter an advantage, as the hunter sits up in a tree. This allows the hunter to see over intervening brush and vegetation that might otherwise block the hunter's view of approaching game. The advantage is not always clear, however, as early fall hunting in hardwoods bottoms can result in shortened line of sight, mostly because of heavy foliage still on the trees.

Hunters may use climbing stands to take the stand to different locations easily. Although not permanent like ladder stands and hanging stands, they can relocate a hunter to a different tree easily. Some hunters leave them in the woods at the base of the tree. Climbing stands allow hunters that want to hunt from them to use a climbing stand at a location that will not allow them to keep a stand up during the whole season. Often ladder stands and hanging stands do not move easily, so they tend to stay on one tree. Because branches limit climbing stand use, ladder stands and hanging stands allow hunters more options on the trees with many branches at a lower height.

There are heretofore unaddressed needs in regards to support systems attached to previous solutions of hunting stands.

### SUMMARY

Example embodiments of the present disclosure provide hunting stand support systems. Briefly described, in architecture, one example embodiment of the system, among others, can be implemented as follows: a hunting stand comprising: a rail; and a support system comprising: a first bracket comprising a first notch; a second bracket; a support device connected to the second bracket; and at least one fastener configured to clamp the second bracket to a top of a rail of a hunting stand and to clamp the first bracket to a bottom of the rail, the rail fitting in the first notch.

Embodiments of the present disclosure can also be viewed as providing hunting stand support apparatuses. In this regard, one embodiment of such a method, among others, can be broadly summarized by the following elements: a first bracket comprising a first notch; a second bracket; a support device connected to the second bracket; and at least one fastener configured to clamp the second bracket to a top of a rail of a hunting stand and to clamp the first bracket to a bottom of the rail, the rail fitting in the first notch.

### BRIEF DESCRIPTION OF THE DRAWINGS

FIG. 1A is a diagram of an example embodiment of a climbing stand.

FIG. 1B is a diagram of an example embodiment of a ladder stand.

FIG. 1C is a diagram of an example embodiment of a tripod stand.

FIG. 2 is a perspective diagram of an example embodiment of a hunting stand support apparatus.

FIG. 3 is a perspective diagram of an example embodiment of the top bracket of FIG. 2.

FIG. 4 is a perspective diagram of an example embodiment of the bottom bracket of FIG. 2.

FIG. 5 is an exploded diagram of an example embodiment of the apparatus of FIG. 2.

FIG. 6 is a perspective diagram of an example embodiment of a hunting stand support system.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

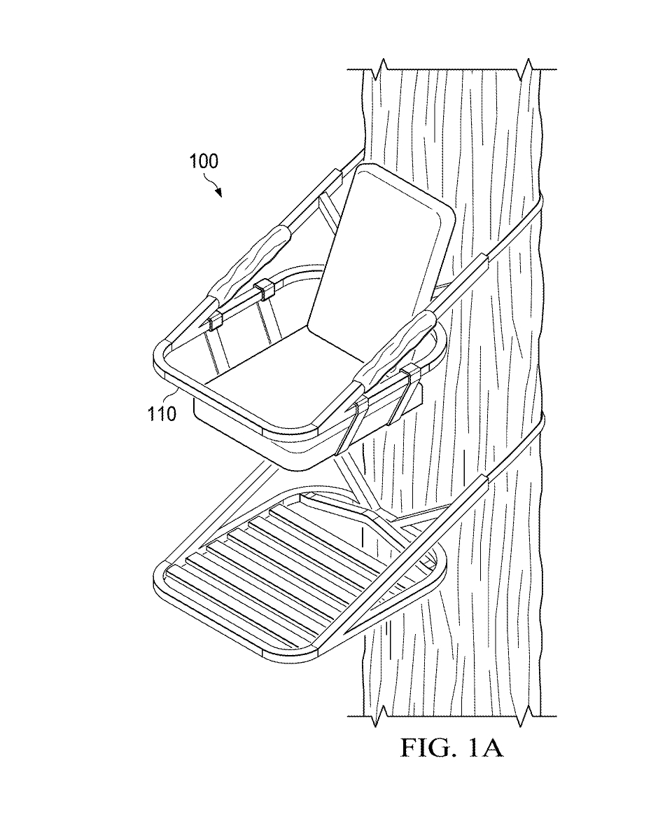

FIG. 1 provides climbing stand 100 with rail 110. As shown, climbing stand 100 may be only large enough for the hunter himself with little to no room to store his gun or anything else. It would be helpful to have a support system for a gun or other item that could clamp to rail 110.

FIG. 1B provides ladder stand 120 with rail 130. Again, as shown, ladder stand 120 may only be large enough for the hunter himself with little to no space to store his gun or anything else.

FIG. 1C provides tripod stand 140 with rail 150. Again, as shown, ladder stand 120 may only be large enough for the hunter himself with little to no space to store his gun or anything else. Rails 110, 130 and 150 may be of various sizes, with the most common widths being 0.75 inches, 1 inch, and 1.625 inches.

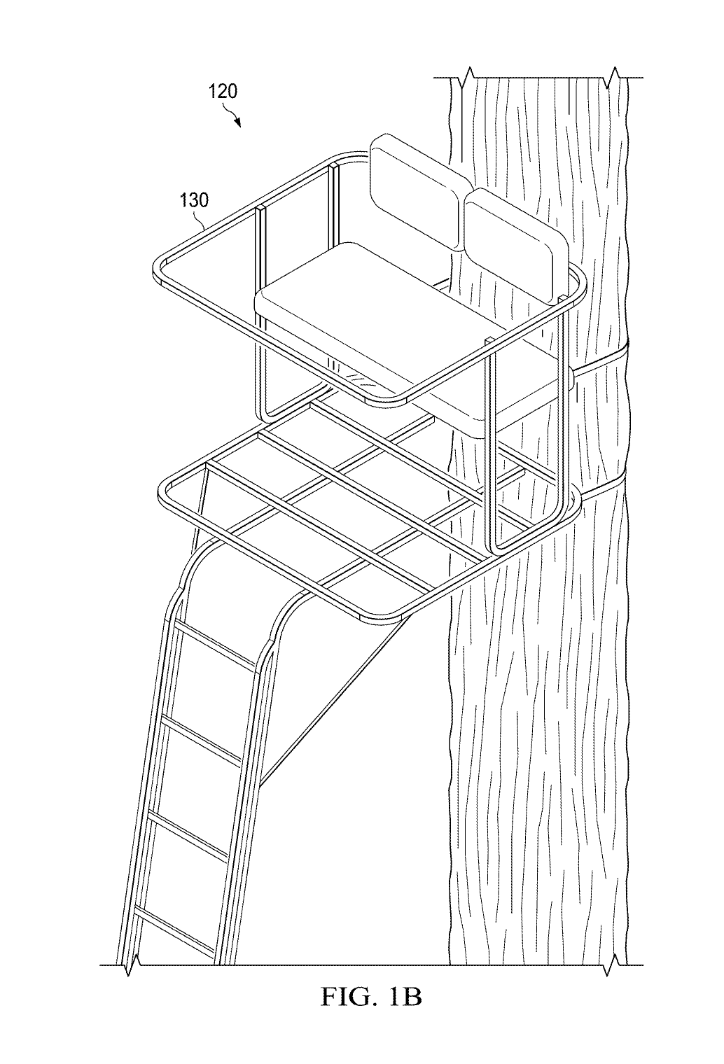

Example embodiments of the hunting stand system and apparatus disclosed herein solve this problem by providing support for a hunting weapon or other object. In an example embodiment, a single support device or apparatus can be used to attach to each of the three common widths. FIG. 2 provides a side view of an example embodiment of a hunting stand support system and apparatus comprising first bracket 220, second bracket 210, support device 230, and a fastener. In the example embodiment of FIG. 2, the fastener comprises bolts 240 and 245 and nuts 270 and 275. In an example embodiment, nuts 270 and 275 are wing nuts. First bracket 220 comprises first notch 250 and second notch 260 with second notch 260 configured to be wider than first notch 250. First notch 250 is configured to fit a first rail size, second notch 260 is configured to fit a second rail size and the distance between bolt 240 and bolt 245 is configured to fit a third rail size.

In an alternative embodiment, a single notch is used and the top of the notch is a jagged or a serrated pattern such that when first bracket 220 is clamped to a rail, the jagged or serrated surface clamps securely to the rail. In an example embodiment, the bottom of second bracket 210 is jagged or serrated. In yet another embodiment, first bracket 220 has no notches and the surface is jagged or serrated. In an alternative embodiment, one or both of first bracket 210 and second bracket 220 has a rubber coating which may have one or more patterns to increase the security of the clamping.

In an example embodiment, support device 230 is attached to second bracket 210. In an alternative embodiment, support device 230 is attached to first bracket 220. Support device 230 may be generally U-shaped or generally V-shaped, or any other shape which may support a desired object. In an example embodiment, support device 230 is constructed of metal. Support device 230 may be covered in rubber or other cushioning material. Support device 230 may be fixedly attached to one of second bracket 210 or second bracket 220. Alternatively, support device 230 may be rotatably attached such that support device 230 may be turned to a different position. Support device 230 may be attached such that it may rotate in any plane.

Bolts 240 and 245 may be welded or fixedly attached to second bracket 210. Alternatively, bolts 240 and 245 may be inserted through holes in second bracket 210. The holes in second bracket 210 are preferably configured to fit the aforementioned third rail size. An example embodiment of the fastener clamps first bracket 220 and second bracket 210 to a rail such that rail fits in at least one of first notch 250, second notch 260, and a third spacing between the fastener. In an example embodiment, the fastener comprises bolt 240 and bolt 245 with nuts 270 and 275. In an alternative embodiment, the fastener comprises a u-bolt or a single fastener comprising two fastening legs. In yet another embodiment, only a single bolt and nut may be used to clamp the brackets to the rail. In an example embodiment, the fastening legs are threaded and secured with a threaded nut. Alternative embodiments include ratcheted fasteners, locking pins, clamps, and rivets, among others.

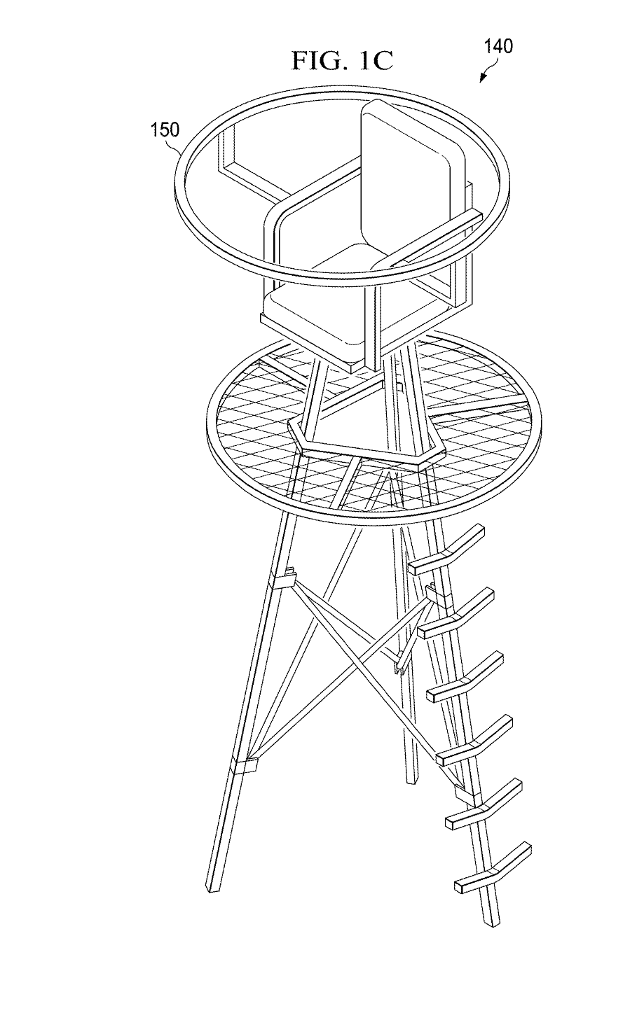

FIG. 3 provides a top view of an example embodiment of hunting stand support apparatus 300 in which second bracket 310 is shown. In an example embodiment, support device 330 is attached to second bracket 310 and holes 335 and 337 through second bracket 310 are spaced so that the fasteners inserted through holes 335 and 337 fit to a particular rail size of a hunting stand.

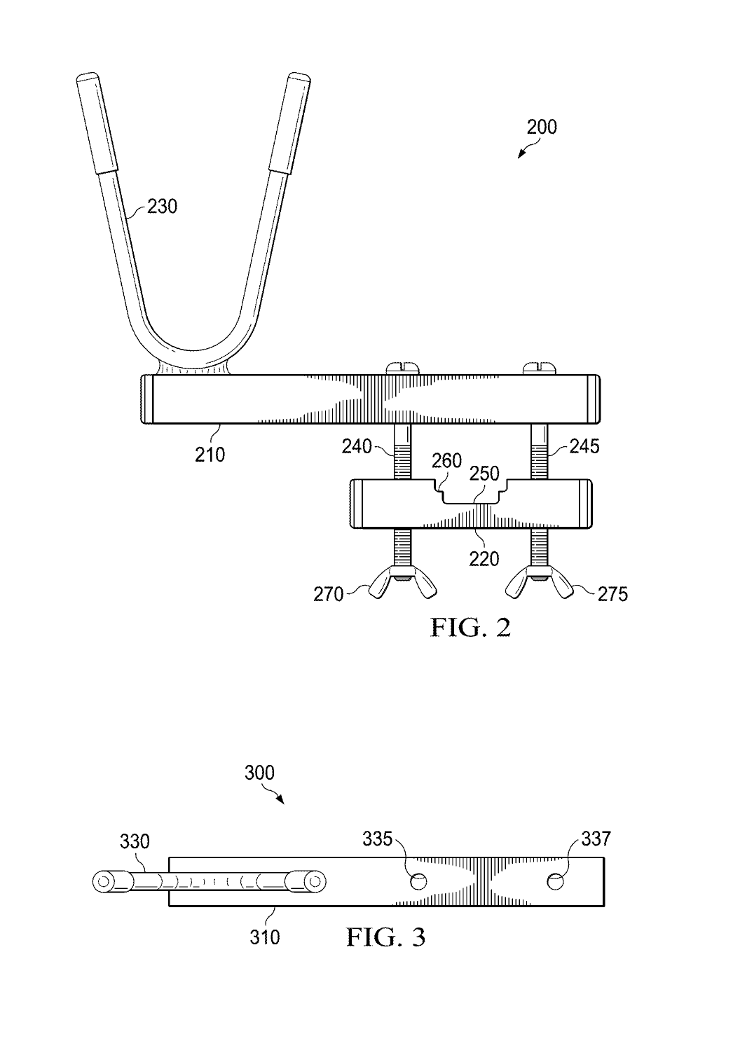

FIG. 4 provides a top view of second bracket 420 with at least one notch provided and holes 438 and 439 through the bracket holes 438 and 439 should match with holes 335 and 357 of FIG. 3.

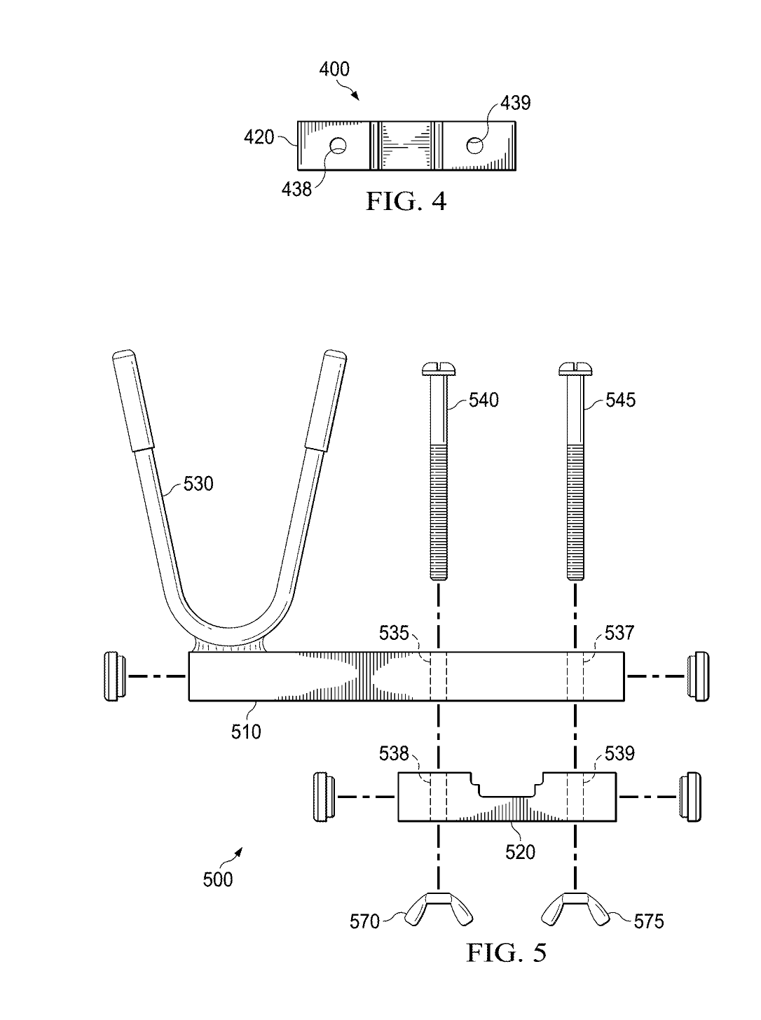

FIG. 5 provides an exploded view of the hunting stand support apparatus of FIG. 2. Hunting stand support apparatus 500 comprises first bracket 520, second bracket 510, support device 530, and a fastener. In the example embodiment of FIG. 5, the fastener comprises bolts 540 and 545 and nuts 570 and 575. In an example embodiment, nuts 570 and 575 are wing nuts. First bracket 520 comprises a first notch and a second notch with the second notch configured to be wider than the first notch. The first notch is configured to fit a first rail size, the second notch is configured to fit a second rail size, and the distance between bolt 540 and bolt 545 is configured to fit a third rail size. Bolts 540 and 545 may be inserted through holes in second bracket 510. The holes in second bracket 510 are preferably configured to fit the aforementioned third rail size. Alternatively, bolts 540 and 545 may be welded or fixedly attached to second bracket 510.

In an example embodiment, support device 530 is attached to second bracket 510. In an alternative embodiment, support device 530 is attached to first bracket 520. Support device 530 may be generally U-shaped or generally V-shaped, or any other shape which may support a desired object. In an example embodiment, support device 530 is constructed of metal. Support device 530 may be covered in rubber or other cushioning material. Support device 530 may be fixedly attached to one of first bracket 510 or second bracket 520. An example embodiment of the fastener clamps first bracket 510 and second bracket 520 to a rail such that rail fits in at least one of the first notch, the second notch, and a third spacing between the fastener.

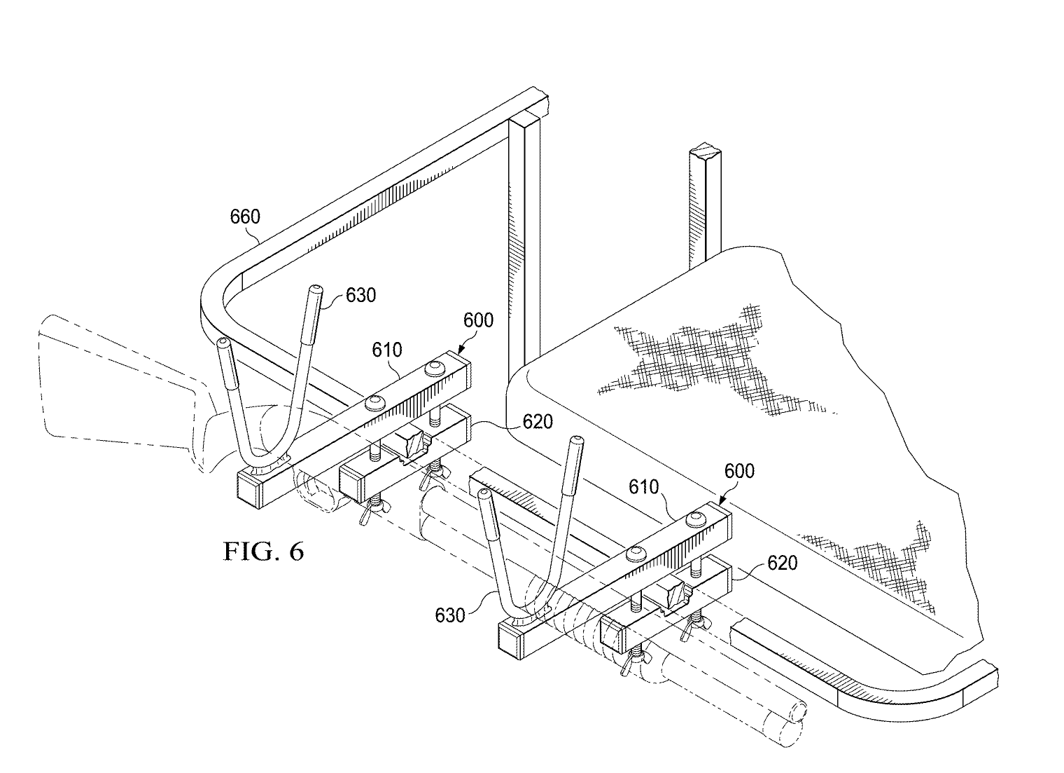

FIG. 6 provides a perspective view of a hunting stand support system.

The hunting stand support system comprises a hunting stand with rail 660 and one or more hunting stand support apparatuses 600. Each hunting stand support apparatus 600 comprises first bracket 620, second bracket 610, support device 630, and a fastener. First bracket 620 comprises a first notch and a second notch with the second notch configured to be wider than the first notch. The first notch is configured to fit a first rail size, the second notch is configured to fit a second rail size, and the distance between the fastener is configured to fit a third rail size. In an example embodiment, first bracket 610 fits over rail 660 and second bracket 620 fits under rail 660 such that rail 660 fits in at least one of the first notch, the second notch, and a third spacing between the fastener. Two apparatuses are shown attached to the rail of FIG. 6, but more or less may be used in a hunting stand support system.

Although the present invention has been described in detail, it should be understood that various changes, substitutions and alterations can be made thereto without departing from the spirit and scope of the invention as defined by the appended claims.

Therefore, at least the following is claimed:

1. An apparatus comprising:
a first bracket comprising a first notch;
a second bracket;
a support device connected to the second bracket; and
at least one fastener configured to clamp the second bracket to a top of a rail of a hunting stand and to clamp the first bracket to a bottom of the rail, the rail fitting in the first notch.

2. The apparatus of claim 1, wherein the first bracket comprises a second notch wider than the first notch.

3. The apparatus of claim 2, wherein the first notch is positioned within the second notch.

4. The apparatus of claim 1, wherein the at least one fastener comprises a bolt and a nut.

5. The apparatus of claim 4, wherein the nut is a wing nut.

6. The apparatus of claim 1, wherein the at least one fastener comprises two bolts and nuts, wherein one bolt and nut is positioned on a first side of the first notch and the other bolt and nut is positioned on the opposite side of the first notch.

7. The apparatus of claim 6, wherein the first notch fits a first rail size, a second notch fits a second rail size, and the spacing between the two bolts fits a third rail size.

8. The apparatus of claim 1, wherein the fastener comprises a u-bolt inserted through the second bracket and the first bracket with at least on end secured.

9. The apparatus of claim 1, wherein the support comprises a general U-shape.

10. The apparatus of claim 1, wherein the support comprises a general V-shape.

11. A system comprising:
a hunting stand comprising:
a rail; and
a support system comprising:
a first bracket comprising a first notch;
a second bracket;
a support device connected to the second bracket; and
at least one fastener configured to clamp the second bracket to a top of a rail of a hunting stand and to clamp the first bracket to a bottom of the rail, the rail fitting in the first notch.

12. The system of claim 11, wherein the first bracket comprises a second notch wider than the first notch.

13. The system of claim 12, wherein the first notch is positioned within the second notch.

14. The system of claim 11, wherein the at least one fastener comprises a bolt and a nut.

15. The system of claim 14, wherein the nut is a wing nut.

16. The system of claim 11, wherein the at least one fastener comprises two bolts and nuts, wherein one bolt and nut is positioned on a first side of the first notch and the other bolt and nut is positioned on the opposite side of the first notch.

17. The system of claim 16, wherein the first notch fits a first rail size, a second notch fits a second rail size, and the spacing between the two bolts fits a third rail size.

18. The system of claim 11, wherein the fastener comprises a u-bolt inserted through the second bracket and the first bracket with at least on end secured.

19. The system of claim 11, wherein the support comprises at least one of a general U-shape and a general V-shape.

20. The system of claim 11, wherein the hunting stand comprises at least one of a tripod stand, a ladder stand, a climbing stand, and a hanging stand.
